(19) United States
(12) Patent Application Publication
(10) Pub. No.: US 2005/0093363 A1
(43) Pub. Date: May 5, 2005

(54) Custom wheel assembly

(76) Inventor: Ronald E. Necaise, San Antonio, TX (US)

Correspondence Address: Michelle L. Evans;Gunn & Lee, P.C., Suite 1500, 700 N. St. Mary's, San Antonio, TX, 78205, US

(21) Appl. No.: 10/903,677

(22) Filed: Jul. 30, 2004

Related U.S. Application Data
(60) Provisional application No. 60/516,005, filed on Oct. 31, 2003.

(51) Int. Cl. B60B 7/04

(52) U.S. Cl. 301/37.25

(57) ABSTRACT

A custom wheel assembly for use in mounting spinners to hub centric wheels. This is accomplished through the use of a mandrel hub that is placed through the center bore of a hub centric wheel. This mandrel hub incorporates a shaft that permits the attachment of a spinner to the wheel.

This application claims priority to U.S. Provisional Patent Application Ser. No. 60/516,005 filed Oct. 31, 2003.

### BACKGROUND OF THE INVENTION

1. Field of the Invention

Applicant's invention relates to custom wheels and more particularly a custom wheel assembly that incorporates a mandrel hub for attaching wheel spinners to hub centric wheels.

2. Background Information

Nowadays, there is a general trend among vehicle owners to make their vehicles more attractive by the addition of custom wheel spinners. Unfortunately, not only are custom wheel spinners expensive, but many currently do not fit appropriately with some hub centric wheels. In many instances, in order to secure the spinners to these hub centric wheels, techniques are used which can lead to faulty vehicle operation and/or extensive vibration.

There is no known art which secures the spinner to the hub centric wheel without sacrificing vehicle safety and operation and/or without extensive vibration. The present invention was designed to satisfy this need in the art. The benefit of the present invention is accomplished through the use of a mandrel hub which is placed behind the wheel and through the wheel bore before placement of the wheel onto the wheel hub. The mandrel hub incorporates a shaft on to which the wheel spinner can be attached. The mandrel hub of the present invention is particularly designed to work in coordination with the custom wheel assembly of the present invention and can be adapted for use with all vehicles and wheel hub types. In addition, with obvious modifications the mandrel hub can be adapted to conform to any known or obvious custom wheel assemblies as well as any newly developed vehicles and wheel hub types.

### SUMMARY OF THE INVENTION

It is a primary object of the present invention to provide a novel custom wheel assembly that can be used to attach wheel spinners to hub centric wheels.

Still another object of the present invention is to provide a novel custom wheel assembly that can be used to reduce and/or eliminate vibration in wheels that incorporate spinners.

Another object of the present invention is to provide a novel custom wheel assembly that incorporates a mandrel hub designed to fit within the wheel bore.

An additional object of the present invention is to provide a novel custom wheel assembly that includes a mandrel spacer for attachment over the mandrel hub.

Still another object of the present invention is to provide a novel custom wheel assembly that incorporates a spinner for attachment to the mandrel hub.

Yet another object of the present invention is to provide novel custom wheel assembly that is designed to keep the spinner within the depth of the wheel for visual appeal.

Still an additional object of the present invention is to provide novel custom wheel assembly that incorporates a ring within the mandrel hub having an outer diameter to fit within the mandrel hub, but an inner diameter that varies so the wheel can be attached to any size wheel hub to make the wheel hub-centric.

Another object of the present invention is to provide a novel custom wheel assembly that incorporates a lip at the base of the mandrel hub.

An additional object of the present invention is to provide a novel custom wheel assembly that includes a spindle sleeve with an encased bearing that can be placed over the mandrel hub to permit independent rotation of the spinner.

In satisfaction of these and related objectives, Applicant's present invention provides a custom wheel assembly that incorporates a mandrel hub for attaching spinners to hub centric wheels and for reduction and/or elimination of vibration in vehicles incorporating such hub centric wheels with spinners.

### BRIEF DESCRIPTION OF THE DRAWINGS

FIG. 1 is a general exploded view of a custom wheel assembly incorporating a hub ring as disclosed by the present inventor in U.S. Pat. No. 6,398,311.

FIG. 2 is a more detailed illustration showing additional components that can be added to the custom wheel assembly to provide clarification as to the scope of application of the invention disclosed in U.S. Pat. No. 6,398,311.

FIG. 3 is an exploded view of the preferred embodiment of the custom wheel assembly of the present invention.

FIG. 4 is a perspective view of the preferred embodiment of the mandrel hub of the custom wheel assembly of the present invention.

FIG. 5 is a perspective view of the preferred embodiment of the mandrel spacer of the custom wheel assembly of the present invention.

FIG. 6 is a diagrammatic view of the mandrel hub in relation to a spindle sleeve and the spinner.

### DETAILED DESCRIPTION OF THE PREFERRED EMBODIMENT

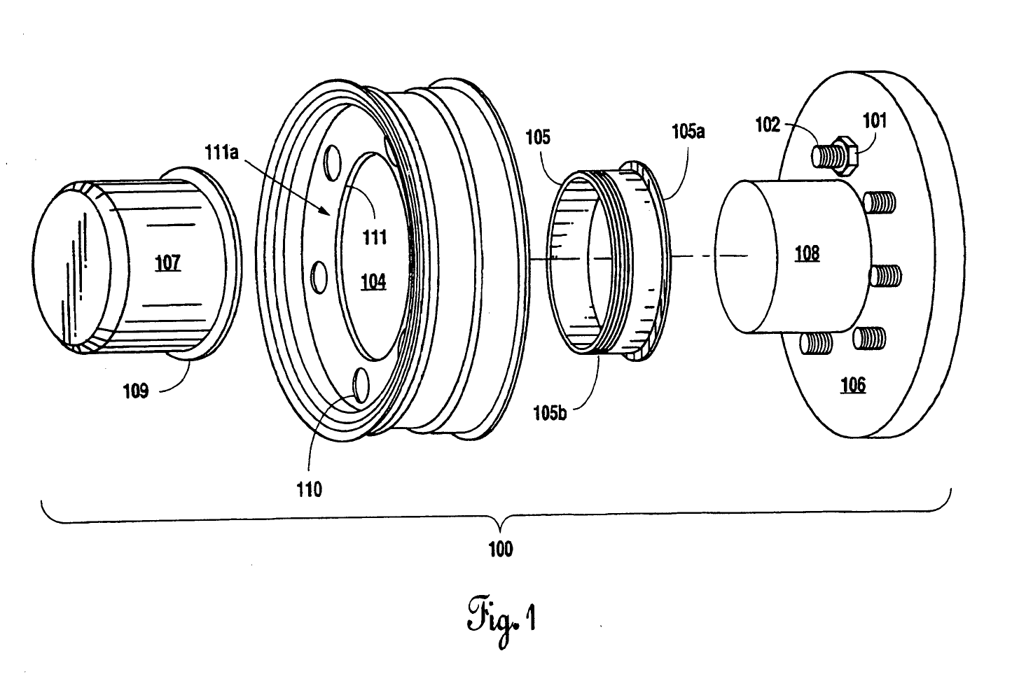

FIG. 1 is a general exploded view of a custom wheel assembly incorporating a hub ring 105 as disclosed by the present inventor in U.S. Pat. No. 6,398,311. This hub ring 105 was used to render non-hubcentric wheels hub centric to reduce and/or eliminate vibration on vehicles incorporating non-hubcentric wheels. In this FIG. 1, there is shown a vehicle wheel assembly 100 having a vehicle wheel hub 106, being circular and of appropriate dimensions and of appropriate material for the vehicle of interest, with a plurality of lugs 102 and an equal amount of lug nuts 101. The lugs 102 are preferably spaced equally apart in a circle around the center of vehicle wheel hub 106 with lug nuts 101 placed thereon. The hub ring 105 is placed over a center hub 108 located at the center of vehicle wheel hub 106. The hub ring 105 is made from a material suitable for its purpose and of appropriate dimensions for the vehicle of interest which can vary with hub manufacturer and hub size. The hub ring 105 has a material thickness suitable for the vehicle of interest and is preferably threaded at a first side 105b having preferably a first lip 105a that preferably lays flat against vehicle wheel hub 106 with a radius lip portion (not shown) fitting into the wheel 111 to hold ring 105 in place. The threads of hub ring 105 extend preferably approximately ½ inch from first side 105b.

The first side 105b of said hub ring 105 is inserted into the central bore 104 of a first side 111a of a wheel 111. The wheel 111 is conventional for the make and model of the applicable vehicle and contains a plurality of openings 110 for accessing air to the brake drums. This insertion of hub ring 105 into central bore 104 renders the wheel 111 hub-centric on the vehicle. The threaded portion of the hub ring 105 will protrude through the wheel 111 and out of the central bore 104 of the wheel 111 allowing for a center cap 107 to be installed over the center hub 108. Center cap 107 is of appropriate dimension to be placed over center hub 108 to complete the custom wheel assembly 100. Center cap 107 is preferably threaded inside and frictionally attaches, but preferably screws onto the threaded portion of hub ring 105. The hub ring 105 and the center cap 107 are threaded in the appropriate direction to permit tightening of the assembly each time the vehicle is in motion. The inside diameter of center cap 107 varies according to the make and model of the vehicle. Center cap 107 is preferably made from aluminum or plastic, but may be made from any suitable material. Once center cap 107 is in place, second lip 109 lays flat against wheel 111. Center cap 107 is held in place preferably with a screw, and most preferably with a black torx headed set screw. The center cap 107 may contain indicia and/or design elements for various custom wheel assemblies.

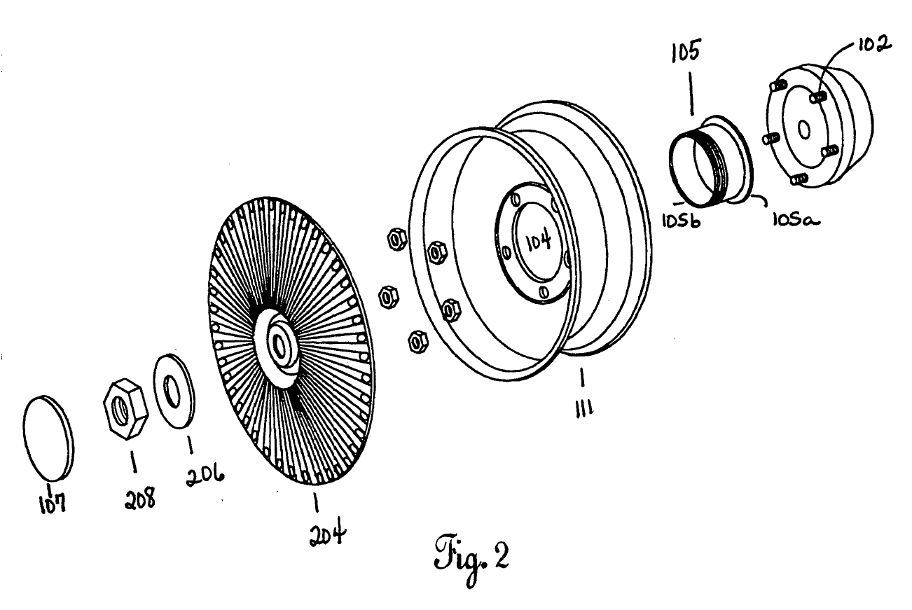

In a more detailed illustration shown in FIG. 2, additional components are added to the custom wheel assembly 100 to provide clarification as to the scope of application of the invention disclosed in U.S. Pat. No. 6,398,311. Positioned in front of hub ring 105 is spinner 204. A first washer 206 is next positioned over spinner 204 followed by a locking nut 208. The locking nut 208 is designed to lock the spinner 204 to the hub ring 105. Center cap 107 is then placed over the locking nut 208.

While the hub ring 105 has been useful for rendering non-hubcentric wheels hub centric to reduce and/or eliminate vibration, this hub ring 105 has also been found to reduce and/or eliminate vibration even in hub centric wheels particularly where additional components have been added to the wheels such as spinners. However, there are some types of hub centric wheels which do not permit the placement of hub ring 105. It is for these types of wheels that the present invention was designed.

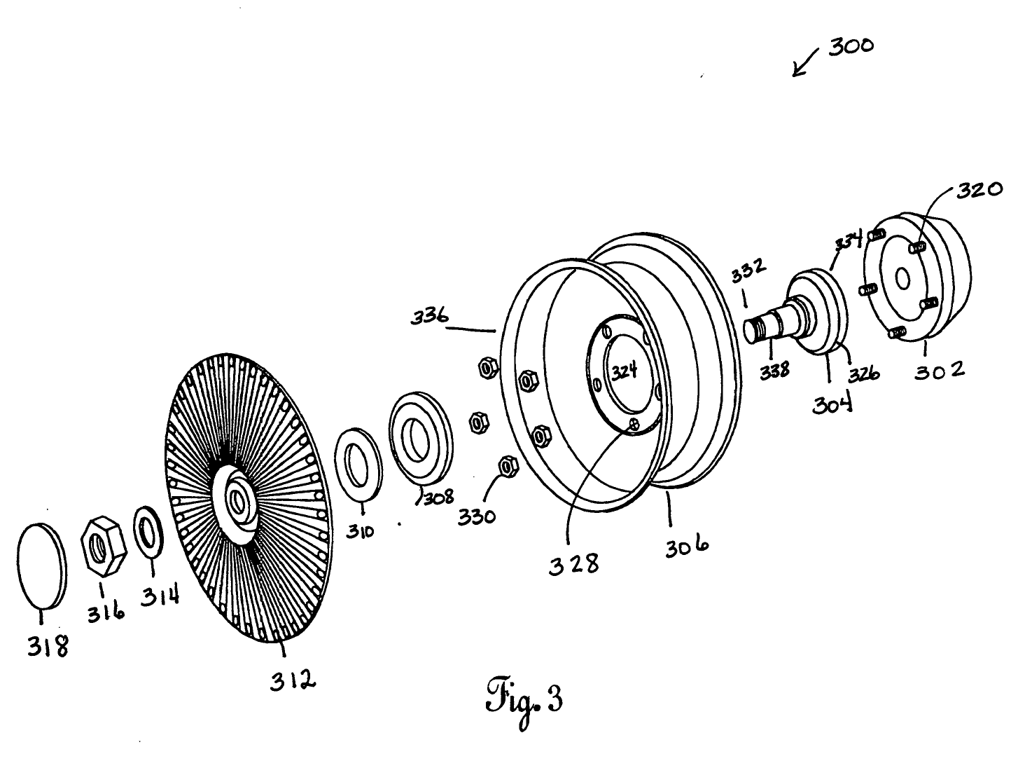

In FIG. 3, an exploded view of the preferred embodiment of the custom wheel assembly 300 of the present invention is shown. There is shown a custom wheel assembly 300 having a vehicle wheel hub 302, being circular and of appropriate dimensions and of appropriate material for the vehicle of interest, with a plurality of lugs 320. The lugs 320 are preferably spaced equally apart in a circle around the center of vehicle wheel hub 302. A mandrel hub 304, having first end 332 and second end 334, is placed through the wheel bore 324 of wheel 306 to form a snug fit against wheel bore 324 at point 326. The second end 334 of mandrel hub 304 can include a lip (not shown) similar to first lip 105a (FIG. 1) of hub ring 105 (FIG. 1). The mandrel hub 304 is made from a material suitable for its purpose and of appropriate dimensions for the vehicle of interest which can vary with hub manufacturer and hub size. The mandrel hub 304 has a material thickness suitable for the vehicle of interest. The wheel 306 is conventional for the make and model of the applicable vehicle and may contain a plurality of openings (not shown) for accessing air to the brake drums. The wheel bore 324 of the wheel 306 can be of any diameter, but is defined as the same diameter as the center hub 322 for hub centric wheels. Wheel 306 having lug openings 328 is then placed over vehicle wheel hub 302 and secured to vehicle wheel hub 302 with lug nuts 330. Once wheel 306 is secured to vehicle wheel hub 302, second end 334 of mandrel hub 304 is centered over center hub 322 located at the center of vehicle wheel hub 302. First end 332 which is preferably threaded extends to the front 336 of wheel 306.

The first end 332 of mandrel hub 304 is positioned on a shaft 338 extending from a base 340. This shaft 338 allows for a mandrel spacer 308 to slide over the shaft 338 and fit down onto the base 340 of mandrel hub 304. A first washer or spacer 310 is provided and added to the shaft 338 of mandrel hub 304. A spinner sleeve 360 (FIG. 6) next slides over shaft 338. Spinner sleeve 360 (FIG. 6) has an encased bearing and incorporates alignment grooves 364 (See FIG. 6) on its exterior which are designed to align with mating alignment notches 362 (FIG. 6) on spinner 312. Spinner 312, which has a central opening, is then placed over shaft 338 of mandrel hub 304 and alignment notches 362 (FIG. 6) mate with alignment grooves 364 (FIG. 6) of spinner sleeve. Once mated, the spinner 312 can rotate freely on the shaft 338 with spinner sleeve 360 (FIG. 6) aiding in the stabilization of spinner 312 on wheel 306. The assembly 300 is inspected for proper spinner 312 to wheel 306 clearance. With spinner 312 in place over shaft 338, a second washer 314 is placed over spinner 312. Locking nut 316 is then threaded onto the threads of first end 332 of mandrel hub 304. A center cap 318 of appropriate dimension is placed over locking nut 316 to complete the custom wheel assembly 300. The inside diameter of center cap 318 varies according to the spinner type. Center cap 318 is preferably made from aluminum or plastic, but may be made from any suitable material. The center cap 318 may contain indicia and/or design elements for various custom wheel assemblies. The overall design of the present invention can keep the spinner 312 within the depth of the wheel 306 for visual appeal. While each part has been discussed separately, it is understood that many if not all of the parts described herein can be attached prior to assembly to other parts described herein and would be considered obvious to those skilled in the art.

FIG. 4 is a perspective view of the preferred embodiment of the mandrel hub 304 of the custom wheel assembly 300 of the present invention. Mandrel hub 304 is provided having first end 332 and second end 334. First end 332 is designed to be placed through the wheel bore 324 (See FIG. 3) of wheel 306 (See FIG. 3) to form a snug fit against wheel bore 324 (See FIG. 3) at point 326 of mandrel hub 304. The second end 334 of mandrel hub 304 can include a lip (not shown) similar to first lip 105a (FIG. 1) of hub ring 105 (FIG. 1). Mandrel hub 304 can have a hollow interior that can incorporate a ring (not shown) having an outer diameter to fit against the inner walls of mandrel hub 304, but an inner diameter that varies so the wheel 306 can be attached to any size wheel hub 302 to render wheel 306 hub centric, if necessary. Once wheel 306 (See FIG. 3) is secured to vehicle wheel hub 302 (See FIG. 3), second end 334 of mandrel hub 304 is centered over center hub 322 (See FIG. 3) located at the center of vehicle wheel hub 302 (See FIG. 3). First end 332 which is preferably threaded extends to the front 336 (See FIG. 3) of wheel 306 (See FIG. 3).

The first end 332 of mandrel hub 304 is positioned on a shaft 338 extending from a base 340. This shaft 338 allows for a mandrel spacer 308 (See FIG. 3) to slide over the shaft 338 and fit down onto the base 340 of mandrel hub 304. A first lip 346 is provided at the base of shaft 338 over which mandrel spacer 308 (See FIG. 3) is placed. A second lip 348 is also provided.

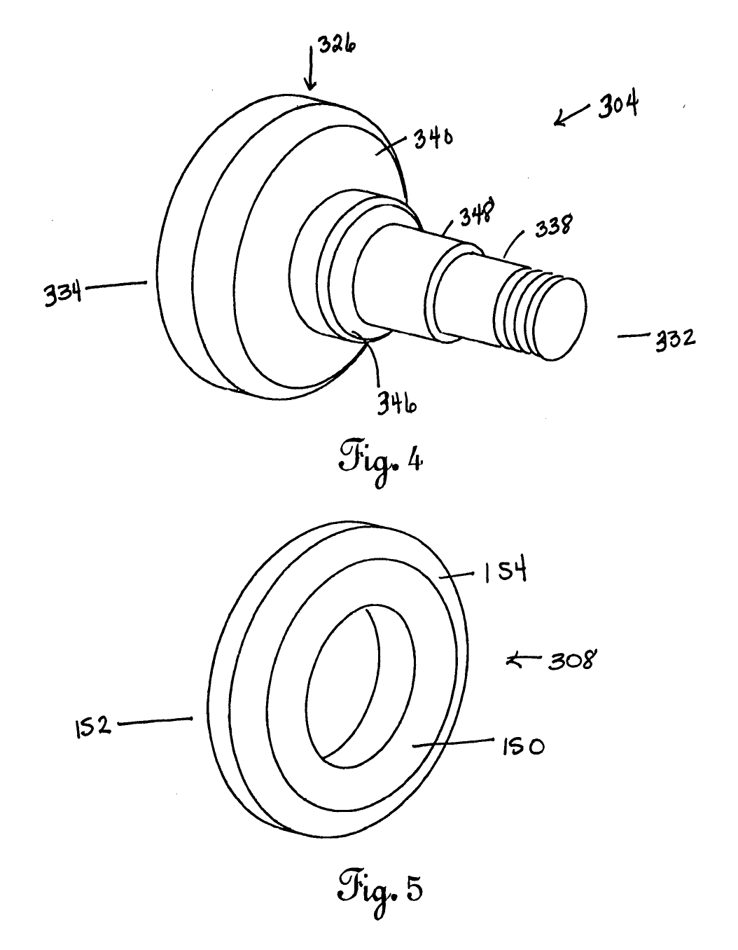

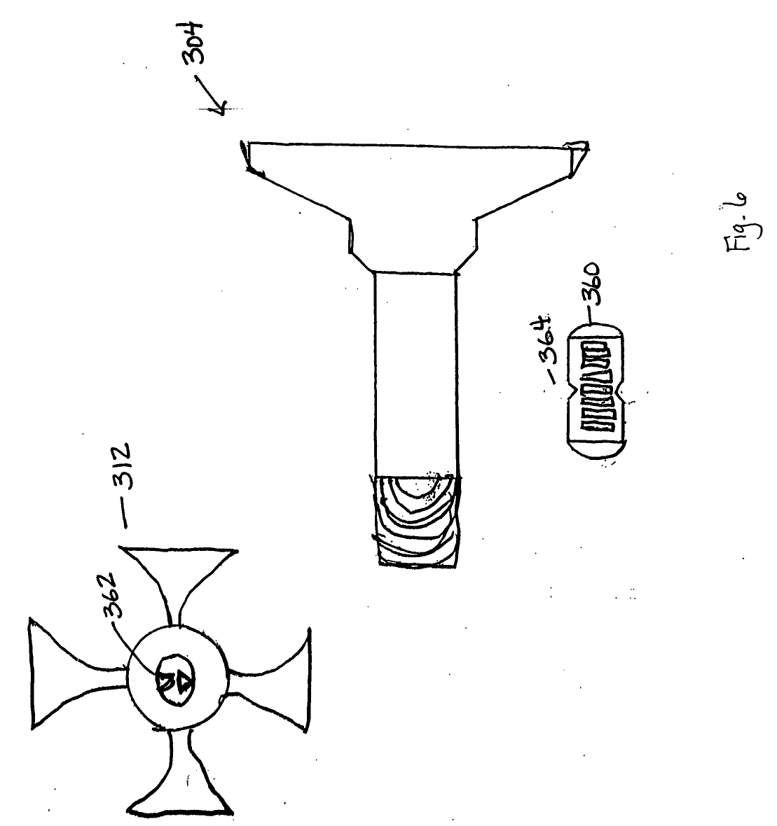

FIG. 5 is a perspective view of the preferred embodiment of the mandrel spacer 308 of the custom wheel assembly 300 of the present invention. The mandrel spacer 308 has a central opening intended to be placed over shaft 338 (See FIG. 4) of mandrel hub 304 (See FIG. 4). Mandrel spacer 308 includes a front side 350 and a back side 352 with a lip 354.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is therefore contemplated that the appended claims will cover such modifications that fall within the scope of the invention.

1. A custom wheel assembly to reduce vibration of a vehicle utilizing custom wheels comprising:
a wheel hub having a plurality of equispaced lugs;
a mandrel hub, wherein said mandrel hub is placed at the center of said wheel hub inside the perimeter established by said equispaced lugs;
a wheel through which is inserted an upper threaded portion of said mandrel hub; and
an accessory removably threaded to said upper threaded portion of said mandrel hub.

2. The custom wheel assembly of claim 1 wherein said accessory is a spinner.

3. The custom wheel assembly of claim 2 further comprising a cover placed onto the center of said spinner.

4. The custom wheel assembly of claim 3 further comprising a spacer placed over said mandrel hub.

5. The custom wheel assembly of claim 4 wherein said mandrel hub comprises a shaft extending from a base.

6. The custom wheel assembly of claim 5 further comprising a spinner sleeve positioned over said shaft.

7. The custom wheel assembly of claim 6 wherein said spinner sleeve comprises an encased bearing.

8. The custom wheel assembly of claim 6 wherein said spinner sleeve comprises exterior alignment grooves for mating with said spinner.

9. The custom wheel assembly of claim 8 wherein said mandrel hub houses a ring within said base.

10. The custom wheel assembly of claim 9 wherein said spinner comprises alignment notches for mating with said spinner sleeve.
